(19) United States
(12) Patent Application Publication
(10) Pub. No.: US 2014/0200788 A1
(43) Pub. Date: Jul. 17, 2014

(54) ARRANGEMENT AND METHOD FOR ADAPTING A CRUISE CONTROL SYSTEM IN A VEHICLE

(71) Applicants: Anders Eriksson, Torslanda (SE); Johan Bjernetun, Göteborg (SE)

(72) Inventors: Anders Eriksson, Torslanda (SE); Johan Bjernetun, Göteborg (SE)

(73) Assignee: VOLVO LASTVAGNAR AB, Göteborg (SE)

(21) Appl. No.: 14/343,034

(22) PCT Filed: Sep. 6, 2011
(86) PCT No.: PCT/EP2011/004479

§ 371 Date: Mar. 28, 2014

(51) Int. Cl. B60K 26/00

(52) U.S. Cl. CPC B60K 26/00
USPC 701/93

(57) ABSTRACT

An arrangement for adapting a cruise control system in a vehicle includes a cruise control modifier unit connected to a cruise control system, where the cruise control modifier unit includes a position input arrangement adapted to receive actual position information from a position source, a map input arrangement adapted to receive road information from a map database for a predefined section ahead of the vehicle, where the arrangement is adapted to modify cruise control parameters for a road section within the predefined section depending on the received position and map information. Behavior of the cruise control of a vehicle can be adapted to upcoming road profile changes, which makes it possible to optimize the fuel consumption of the vehicle.

### BACKGROUND AND SUMMARY

The present invention relates to an arrangement and a method for adapting a cruise control system of a vehicle. The invention further relates to a computer program adapted to perform such a method in a cruise control system when said program is run on a computer, and a computer program product comprising such program code means stored on a computer readable medium. The arrangement is suitable for vehicles of different kinds.

Modern vehicles are often provided with a cruise control system in order to improve the comfort of a driver. Some cruise control system are provided with further functions, such as an adaptive control system that uses distance measuring equipment to monitor the distance to a vehicle in front of the own vehicle, in order to be able to adapt the cruise speed to the speed of the vehicle in front. Such a system will improve the safety of the cruise control system since a minimum distance to the vehicle in front will be maintained. Some systems will also brake the vehicle if the minimum distance is not maintained, or if the distance to the vehicle in front decreases at a certain rate. The cruise control system may be adapted to maintain a set speed by using only the accelerator, or by also using the brakes of the vehicle. This is especially common in heavy vehicles which are equipped with auxiliary brakes, such as engine brakes and retarders.

The cruise control system has a regulating range in which the actual speed value is maintained. For a system using only the accelerator to maintain the speed, an excessive speed of a few percent may be allowed. Typically, the speed may vary between e.g. 68 to 72 km/h when the speed is set to 70 km/h. It may be possible to set the maximal allowed excessive speed value for the vehicle. In this way, the system can allow the vehicle to travel at an excessive speed at certain occasions, e.g. when travelling on a slight descent.

When the brake system is also used to maintain the speed of the vehicle, referred to as a brake cruise system, a specified excessive speed can also be allowed for a vehicle rolling down a fairly steep downhill slope. An allowed excessive speed may help to preserve energy by using the momentum of the vehicle. The limit for the allowed excessive speed must of course be set to a value that does not endanger other vehicles.

There are however situations in which the traditional regulating method of the cruise control system does not work in a fuel efficient way. Such situations may e.g. be when the vehicle travels in ascents and descents or when a sudden change in pace is required.

In order to preserve energy and to improve the driveability of a vehicle, a system that uses information about the terrain to adapt the cruise control system of the vehicle is known from U.S. Pat. No. 6,374,173, which discloses an electronic vehicle system which monitors vehicle parameters and calculates variables such as acceleration to determine when the vehicle is cresting a hill. An action is taken to alter operation of the cruise control to avoid expending excess fuel or braking as the vehicle descends the downward grade. A message may be displayed to a driver indicating that the driver should reset the cruise set speed. The system may also reset the cruise set speed automatically without driver intervention. The system may automatically reset the cruise set speed and automatically increase the set speed as the vehicle accelerates.

This system detects that the vehicle is cresting a hill by sensing the deceleration of the vehicle. The set cruise speed is thus altered such that the vehicle will not try to accelerate when the crest is reached. In a normal cruise control regulation, the actual speed of the vehicle would be lower when reaching the crest, which would lead to an acceleration of the vehicle. Such a system may work well in certain situations, but there is still room for improvements.

It is desirable to provide an improved arrangement for adapting the operation of a cruise control system of a vehicle. It is also desirable to provide an improved method for adapting the operation of a cruise control system of a vehicle.

In an arrangement for adapting a cruise control system in a vehicle, the cruise control modifier unit can temporarily modify the cruise control parameters in order to adapt the vehicle behaviour to the surrounding circumstances. When the cruise control modifier unit detects a specific circumstance ahead of the vehicle, in which it may be of advantage to temporarily modify the cruise control parameters, a temporary modification of the cruise control parameters is calculated. Depending on the type of modification, the modification may be used directly by the system or the modification is presented to the driver. The driver in turn has the options of accepting the modification, rejecting the modification or to alter the modification. If the driver accepts the suggested modification, the cruise control will regulate by using the modified parameters for a predefined road section. If the driver rejects the suggested modification, the cruise control will continue to regulate with the nominal set parameters. If the driver alters the parameters, the cruise control will regulate by using the altered parameters for the predefined road section.

By this first embodiment of the arrangement, the cruise control modifier unit receives the actual position of the vehicle from a positioning means. The cruise control modifier unit further receives map information from a map database comprising road condition and road characteristics, including elevation of the road, preferably the elevation above mean sea level but a relative height measure may also be used. Important is that the cruise control modifier unit can assess the upcoming changes in road profile from the elevation data. Further conditions of the road, such as upcoming bends or speed limits may also be used for the adaptation of the cruise control parameters. The received map information covers a predefined section ahead of the vehicle. The size of the predefined section may be fixed to a suitable size or may be set depending on e.g. the actual speed of the vehicle. The cruise control modifier unit will then calculate a prediction of optimized vehicle behaviour for a road section within the predefined section. Since the purpose of the modifications of the cruise control parameters is to optimize the fuel consumption of the vehicle at relatively large changes in road characteristics, it is of advantage if the predefined section is relatively large, covering at least a few kilometers ahead of the vehicle. The suggested modification of the cruise control parameters is then predicted and suggested for a road section within this predefined section. The length of the road section will vary and will depend on the next change in road conditions. The temporary modification of the cruise control parameters will be valid only for the selected road section. When the road section is passed, the temporary modification is not valid anymore and the cruise control will continue to regulate using the nominal set cruise control parameters. Alternatively, a new cruise control modification may be suggested by the cruise control modifier unit.

In an advantageous development of the inventive arrangement, the arrangement comprises a user interface by which the suggested modification is presented to the driver and by which the driver can give an input to the cruise control modifier unit. The user interface may be the existing user interface in the driver information system of the vehicle or may be a voice operated system. The user interface may further be provided with means for the driver to adjust the suggested modification. In this way, the driver cannot only accept or reject the suggested modification, but the driver can also adapt the suggested modification to the liking of the driver.

In a method for adapting the cruise control system of a vehicle, the steps of obtaining the actual position of the vehicle, receiving road information regarding road characteristics and road topology for a predefined section in front of the vehicle, predicting the vehicle behaviour for a road section within the predefined section by using the actual position and the road information, calculating modified cruise control parameters for the road section and using the calculated modified cruise control parameters as temporary set parameters for the cruise control system are comprised.

With the inventive method, an optimized behaviour of the cruise control system of a vehicle can be obtained, in which the cruise control system is adapted to the road characteristics. In this way, the fuel consumption can be lowered compared with a cruise control using nominal set parameters to regulate the operation of the vehicle.

### BRIEF DESCRIPTION OF DRAWINGS

The invention will be described in greater detail in the following, with reference to the attached drawings, in which

FIG. 1 shows a schematic view of an arrangement for adapting the operation of a cruise control system, and

FIG. 2 shows a schematic flow chart of an inventive method for adapting the cruise control system of a vehicle.

### DETAILED DESCRIPTION

The embodiments of the invention with further developments described in the following are to be regarded only as examples and are in no way to limit the scope of the protection provided by the patent claims. The arrangement is suitable for all kinds of vehicles, but is especially suitable for heavy vehicles such as trucks and busses, since the road conditions, especially the road profile, will affect the fuel consumption for such vehicles to a larger extent.

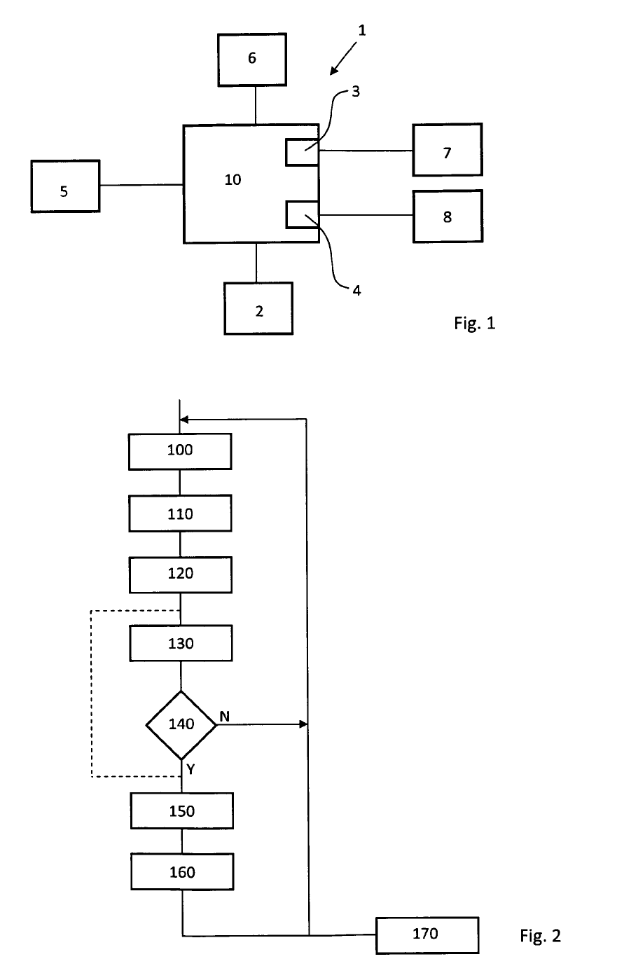

FIG. 1 shows a schematic arrangement for adapting the cruise control system of a vehicle depending on the position of the vehicle and geographical information. The arrangement 1 comprises a cruise control modifier means 10 which communicates with the cruise control system. The cruise control modifier means 10 may be either a standalone control unit connected to the cruise control system or may be integrated e.g. as a software module in the cruise control system or in another electronic control unit (ECU) in the vehicle. In the described example, the cruise control modifier means will be described as a cruise control modifier unit which communicates with other units via discrete lines, even though the units will actually communicate over a vehicle data bus. The cruise control system is often integrated in an ECU as a cruise control program module. The cruise control modifier unit communicates with the cruise control system via an input/output 2. The cruise control modifier unit further comprises a position input 3 and a map input 4. The position input 3 is used to receive information of the actual position of the vehicle. The actual position is preferably obtained from a satellite based position system such as GPS, but other types of position information are also possible to use. Such systems may include a position system based on telecommunication base stations or a system tracking the travel of the vehicle. The map input 4 is used to receive geographical information including topographic information such as elevation and road information. This information may be stored e.g. in a map database in the driver information system of the vehicle or may be received from an external map database. It is important that the map database used to supply the information to the cruise control modifier unit comprises topographic information such that the elevation of the vehicle in the actual position can be obtained, together with the elevation of the road sections to come.

The position information and the map information is used to assess the position of the vehicle on the map and also to assess the upcoming changes in road conditions, e.g. the profile of the road, changes in speed limits or upcoming road bends. By using this information, the condition of the road ahead of the vehicle can be assessed which makes it possible for the cruise control modifier unit to predict an optimal driving configuration for the upcoming road section. This information is used to adapt the behaviour of the cruise control system to the road conditions ahead such that the fuel consumption of the vehicle is optimized to the actual road conditions. In this way, the upcoming road conditions can be predicted and adapted to by the cruise control system in a way that resembles the way an experienced driver drives the vehicle. Since the system can predict conditions ahead of the vehicle, even conditions that cannot be seen by the driver can be accounted for. In this way, the behaviour of the cruise control system will resemble the conduct of an experienced driver driving a familiar route, where the driver is also familiar with upcoming road conditions.

The cruise control modifier unit may also receive information regarding if the cruise control system is activated, the set cruise speed and the set brake cruise speed. The cruise control modifier unit can calculate modified cruise control parameters continuously and send them to the cruise control system, which may use them if the cruise control is active or may discard them if the cruise control is deactivated. It is also possible that the cruise control modifier unit receives information regarding if the cruise control is active, and only then calculates modified cruise control parameters, if the road conditions ahead are such that modified cruise control parameters are useful. When the cruise control system is activated, the cruise control modifier unit will use the position information and the map information to modify the set cruise speed and the set brake cruise speed of the vehicle.

In a first example of the arrangement, the cruise control system is activated and the set cruise speed is 70 km/h. In this example, the position and map information indicates that the vehicle will pass a relatively small hill. Depending on the actual speed of the vehicle, the load of the vehicle, the selected gear and the upcoming road condition, different possibilities for passing the hill in a fuel efficient way may be possible. In this example, the cruise control modifier unit calculates two different possibilities of passing the hill in a fuel conserving way.

For the first possibility, the cruise control modifier unit decides that if an excessive speed of 5 km/h is reached before the ascent begin, the vehicle will be able to pass the hill by using the extra momentum built up without having to use excessive fuel or to change gear. The cruise control modifier unit will also allow the set cruise speed to be lower than the nominal value at the top of the hill.

For the second possibility, an excessive speed cannot be allowed. Instead, the cruise control modifier unit will allow the engine speed value for gear change to be temporarily lowered such that an automatic gear change will not take place. This can be allowed since the cruise control modifier unit can estimate that the top of the hill will be reached before the engine speed drops too much.

The first possibility may be the most energy conserving, but there may be another vehicle in front such that an excessive speed is not allowed. It is thus of importance that the cruise control modifier unit does not select and perform the action by itself in such a case. The detection of a vehicle in front may be done with a distance measuring system, such as a radar system used by an adaptive cruise control. It is also possible to let the driver of the vehicle decide if the suggested action is to be performed or not. In this case, a message can be given to the driver, e.g. by a display or a voice message. The message may e.g. say: excessive speed of 5 km/h in 200 meters. The driver can now decide to allow the action by accepting the suggestion, e.g. by saying yes or by pressing a button. If the driver does not respond to the suggestion, it is discarded. If the first suggestion is not accepted, the cruise control modifier unit may suggest the second possibility to the driver. The driver may accept this possibility or may not, depending e.g. on time pressure. If the driver rejects all suggestions from the cruise control modifier unit, the cruise control system will continue to function in a normal way.

It is not necessary to present all the suggested actions to the driver. Some suggestions, e.g. the ones involving an excessive speed, should be decided by the driver since he/she is responsible for driving the vehicle. Other suggestions may not have to be presented to the driver, e.g. the engine speed for a gear change or the acceleration rate. It may be possible to preset which suggestions that are presented to the driver in a menu system.

When the vehicle is approaching the top of the hill, a new suggestion may be presented to the driver. In this example, the position and map information indicates that there is a relatively sharp bend at the bottom of the hill. The suggestion may then be to allow a lower set cruise speed when passing the top of the hill, e.g. to temporarily use a set cruise speed of 60 km/h and to temporarily allow a brake cruise speed of +5 km/h. In this way, the vehicle will be able to roll down the hill without having to brake in order to handle the bend. The driver may accept these suggestions depending on the conditions. The driver may also, depending e.g. on the load of the vehicle and experience, decide that the suggestion should be modified. If the load has a low centre of gravity and the road condition is dry, the driver may decide to choose a temporary cruise speed of 65 km/h when passing the hill and a brake cruise speed of +8 km/h. The driver may input the new values by using the menu system. The driver may also decide that a suggested value is too high and may input a lower value, e.g. a temporary cruise speed of 55 km/h.

Suitable parameters that can be adjusted by the cruise control modifier unit are excessive speed at ascents, lower speed at crests, excessive brake cruise speed, engine speed for automatic gear change, speed at bends and to allow a lower speed than the set speed when rolling with the clutch disengaged when the road is substantially level, in a so-called eco roll function when the vehicle is freewheeling.

The advantage of the arrangement is that the operation of the vehicle can be adapted to the geographical circumstances and that the driver can accept or decline each proposed modification. In this way, it is possible to preserve fuel by avoiding unnecessary throttle usage and braking and at the same time letting the driver be in control of the vehicle.

In a development of the invention, the suggestions accepted by the driver, the suggestions discarded by the driver and/or the inputs from the driver are stored in a memory together with position information. In this way, these saved values can be used as suggestions the next time the driver travels the same route again. For a driver travelling the same route with the same load, it will thus be possible to personalize the adaptation of the cruise control system of the vehicle to the driver's preference. The stored modified cruise control parameters together with vehicle position information for a specific route may be stored in a route specific memory. In this way, it is possible to have a database with modified parameters for different routes. If the driver is to drive a specific route again, the driver can recall the modified parameters for that specific route.

By storing the modification values for different specific routes in a database, it is possible for a haulage operation to use the modified values for a specific route in all the vehicles in the fleet, at least if the vehicles are from the same manufacturer. It is also be possible to store the modified values in such a manner that they can be used in vehicles of different brands. One advantage of this is that the operation of a vehicle is not dependent on a specific driver, which means that a new or substitute driver driving an ordinary route will be able to reach the same fuel consumption as the ordinary driver. A further advantage of using stored values is that the cruise control modifier unit does not need map information when the values are stored. In this way, a haulage operation which gets a contract for a new route can let an experienced driver drive the route one or a few times in order to optimize the adaptation of the cruise control system. Thereafter, any driver may drive the route with substantially the same fuel consumption. It will also be possible for the haulage operation or for independent companies to supply adapted tables for specific routes.

In a further development, the cruise control modifier unit can also supply information to the driver when the cruise control system is deactivated. The system can, by using the example above, give the driver information regarding the upcoming hill and the subsequent bend after the descend such that the driver may use this information to adapt the speed of the vehicle. This may be advantageous for a driver travelling a route for the first time and where some conditions or obstacles are not visible when the speed decision for a road section is to be taken. In this way, also an experienced driver may lower the fuel consumption. The cruise control modifier unit may also give information about which gear to use for a given ascent such that the driver can prepare for the ascent in advance. The information given to the driver when the cruise control system is deactivated may also be based on the modified parameters stored for a specific route.

FIG. 2 shows a schematic flow chart of a method for adapting a cruise control system in a vehicle according to the invention.

In step 100, the actual position of the vehicle is obtained. The actual position may be obtained from a satellite based position system such as GPS, or from another position information system.

In step 110, the geographical information for a predefined section in front of the vehicle is obtained, including topographic information such as elevation and road characteristics. This information may be obtained e.g. from a map database stored in the driver information system of the vehicle or may be obtained from an external map database. It is important that the map database comprises topographic information such that the elevation of the vehicle in the actual position can be obtained, together with the elevation of the road sections to come.

In step 120, the vehicle behaviour for a road section within the predefined section is predicted. The prediction is calculated based on the position and geographical information obtained, together with e.g. the actual speed of the vehicle and the vehicle load. The calculated prediction of vehicle behaviour is compared with the set speed parameters for the cruise control system.

Depending on the calculated prediction, a modification of the cruise control parameters is obtained. This modification can either be used directly by the cruise control system or may be presented to the driver of the vehicle in step 130. If the calculated modification differs from the nominal cruise control parameters, the modification may be discarded directly. Some modifications may be used directly by the cruise control system, and some may be required to be presented to the driver.

The driver gives an input regarding the suggested modification in step 140. The driver may accept, reject or change the suggested parameters by using the menu system of the driver information system. If the driver does not give an input within a specified time interval, the system may detect this as a rejection. The driver may adjust the suggested parameters by using the menu system such that the driver may fine-tune the behaviour of the vehicle.

If the driver accepts the suggested modification, or if the modification is used directly by the cruise control system, the suggested parameters are used as temporary set parameters for the cruise control system in step 150 for the upcoming road section. If the driver adjusts the parameters, the adjusted parameters will be used as the temporary set parameters for the cruise control system for the road section. If the driver rejects the suggestion, the nominal set parameters of the cruise control system will be used for the road section.

When the vehicle has passed the road section, i.e. when the temporary set parameters has been used to modify the vehicle behaviour for the road section, the temporary cruise control parameters are reset and the nominal set cruise control parameters will be used again in step 160. The system will at the same time obtain new geographical information and new position information. If the conditions of the road ahead are such that the nominal cruise control parameters suffice, they will continue to be used.

The system will continue to receive geographical information together with the position of the vehicle. When a new situation is detected, in which a modification of the cruise control parameters is advantageous, the system will suggest a new modification to the driver.

In step 170, the modified cruise control parameters and the vehicle position is stored in a memory. The modified cruise control parameters may be either the ones suggested by the system, or may be the adjusted values given by the driver. By storing the vehicle position and the cruise control parameters, a database for a specific route is obtained. This database can be used the next time the vehicle travels the same route.

This allows the system to take account of the adjustments made by the driver and to refine future suggestions.

The invention is not to be regarded as being limited to the embodiments described above, a number of additional variants and modifications being possible within the scope of the subsequent patent claims.

### REFERENCE SIGNS

Arrangement for adapting cruise control parameters
2 User interface
3 Position input means
4 Map input means
5 Memory
6 Cruise control
7 Position data
8 Map data
10: Cruise control modifier unit

1. An arrangement (1) for adapting a cruise control system in a vehicle, wherein the arrangement comprises a cruise control modifier unit (10) connected to a cruise control system (6), where the cruise control modifier unit (10) comprises position input means (3) adapted to receive actual position information from a position source (7), map input means (4) adapted to receive road information from a map database (8) for a predefined section ahead of the vehicle, characterized in that the arrangement is adapted to modify cruise control parameters for a road section within the predefined section depending on the received position and map information.

2. Arrangement according to claim 1, characterized in that the arrangement further comprises user interface means (2) adapted to present a suggested modification to the driver and to receive an input from the driver.

3. Arrangement according to claim 2, characterized in that the user interface (2) is provided with means for the driver to adjust the suggested modification.

4. Arrangement according to any of the preceding claims, characterized in that the cruise control parameters include cruise speed, brake cruise speed, acceleration and gear change engine speed.

5. Arrangement according to any of the preceding claims, characterized in that the arrangement further comprises means for storing the modified cruise control parameters together with vehicle position information.

6. Arrangement according to claim 5, characterized in that the stored modified cruise control parameters together with vehicle position information for a specific route is stored in a route specific memory.

7. Arrangement according to claim 5 or 6, characterized in that the stored modified cruise control parameters together with vehicle position information is adapted to be used by several different vehicles in a haulage fleet.

8. Vehicle comprising an arrangement according to any of the preceding claims.

9. A method for adapting the cruise control system of a vehicle, comprising the following steps:
obtaining the actual position of the vehicle,
receiving road information regarding road characteristics and road topology for a predefined section in front of the vehicle,
predicting the vehicle behaviour for a road section within the predefined section by using the actual position and the road information,
calculating modified cruise control parameters for the road section,
using the calculated modified cruise control parameters as temporary set parameters for the cruise control system.

10. Method according to claim 9, further comprising the following steps:
presenting the calculated modification of the cruise control parameters to the driver,
obtaining an input from the driver,
using the suggested modification as temporary set parameters for the cruise control system if the driver approves the suggested modification.

11. Method according to claim 10, further comprising the following steps:
reading an input from the driver containing adjusted modification parameters,
using the adjusted modification as the temporary set parameters for the cruise control system.

12. Method according to any of claims 9 to 11, characterized by that the temporary set parameters are reset after the vehicle has passed the road section.

13. Method according to any of claims 9 to 12, characterized by that the method further comprises the step of storing the modified cruise control parameters together with the vehicle position.

14. A computer program comprising program code means for performing all the steps of anyone of the claims 9-13 when said program is run on a computer.

15. A computer program product comprising program code means stored on a computer readable medium for performing all the steps of any one of the claims 9-13 when said program product is run on a computer.
